(19) United States
(12) Patent Application Publication
(10) Pub. No.: US 2006/0117589 A1
(43) Pub. Date: Jun. 8, 2006

(54) Device and method for supplying moisture into the inner chamber of a tumble dryer

(75) Inventors: Harald Moschutz, Grobeeren (DE); Andreas Ziemann, Potsdam (DE)

Correspondence Address: JOHN T. WINBURN, 100 BOSCH BOULEVARD, NEW BERN, NC, 28562, US

(73) Assignee: BSH Bosch und Siemens Hausgerate GmbH, Munich (DE)

(21) Appl. No.: 10/530,853

(22) PCT Filed: Oct. 14, 2003
(86) PCT No.: PCT/EP03/11358

§ 371 Date: Feb. 21, 2006

(30) Foreign Application Priority Data
Oct. 14, 2002 (DE) 102 47 759.0

(51) Int. Cl. F26B 7/00; F26B 11/02

(52) U.S. Cl. 34/389; 34/597

(57) ABSTRACT

The invention relates to a device (1) for supplying moisture into the interior of a laundry drier, wherein the device (1) comprises a receiving area (3) for receiving liquid and a liquid-impermeable sleeve (2) surrounding this receiving area (3) which has at least one outlet opening for dispensing moisture, wherein the device (1) is characterised in that the sleeve (2) is heat-permeable at least from outside in the direction of the receiving area (3). The invention further relates to a use of this device (1) and a method for supplying moisture into the interior of a laundry drier, characterised in that a device (1) which contains liquid, is inserted in the interior of the laundry drier, heat is produced by means of the heating device of the laundry drier, this heat brings the liquid in the device (1) to vaporise and the moisture thereby obtained is dispensed via at least one outlet opening for moisture in the device (1) onto the interior of the drier.

The present invention relates to a device and a method for supplying moisture into the interior of a laundry drier. The invention further relates to a use of the device.

After a certain time textiles, especially articles of clothing, become laden with odours as a result of body odours or environmental influences and must be washed or cleaned. In order to be able to avoid frequent washing or cleaning and thereby protect the textiles, it is known to air textiles. If the airing is carried out in a domestic laundry drier, solutions are known in which the textiles together with a cloth impregnated with a cleaning agent, is placed in a bag and placed in the domestic laundry drier. After the treatment in the laundry drier, the odours are removed and the article of clothing is scented.

A disadvantage of this treatment is that after the treatment the textiles frequently smell unpleasantly strongly of the cleaning agent. In addition, for each airing process additional costs are incurred for the cleaning cloth.

Further, a drying device for textiles is known from the German utility model GM 7341276. The drying device comprises a steam generator which comprises a heating coil for vaporising water in the housing of the steam generator. For steaming and deodorising textiles, steam from the steam generator is fed into a box-like housing consisting partly of a flexible film in which textiles are suspended.

The disadvantage of this drying device is that this must have a very complex structure in order to make it possible for the steam to be distributed uniformly in the box-like housing. In addition, as a result of the energy required by the steam generator, the energy requirement for this drying device is comparatively high.

It is thus an object of the invention to provide a device and a method for supplying moisture into the interior of a laundry drier, wherein the method should be simple to implement, the device should have a simple structure and in addition, can be operated inexpensively.

The invention is based on the knowledge that this object can be provided by a device in which steam serves as moisture, a heat source already present in the laundry drier is used to produce the steam from a liquid and at the same time, direct contact between the liquid and the textiles to be treated can be reliably avoided.

The object is solved according to the invention by a device for supplying moisture into the interior of a laundry drier according to claim 1, by the use of such a device according to claim 10 and by a method according to claim 11.

Features and details which are described in connection with the device according to the invention also apply to the use according to the invention and for the method according to the invention, and conversely in each case.

The object is solved according to a first aspect of the invention by a device for supplying moisture into the interior of a laundry drier wherein the device has a receiving area for receiving liquid and a liquid-impermeable sleeve surrounding this receiving area, which has at least one outlet opening for dispensing moisture, wherein the device is characterised in that the sleeve is permeable to heat.

Designated as a heat-permeable sleeve in the sense of this invention is a sleeve which as a result of thermal conductivity and/or openings for example in the form of pores, allows such an intake of heat into the receiving area which is sufficient to vaporise the liquid located in the sleeve. As a result of this embodiment of the device, a separate heating device for vaporising the liquid is not required. Rather, the heating device already provided in a laundry drier which in conventional operation of the drier serves to heat the air in the interior of the drier, is used at the same time to vaporise the liquid in the device. This yields technical and economical advantages since the manufacture of the device and its use are facilitated. In addition, since the sleeve is furthermore impermeable to liquid, escape of the liquid located in the receiving area and thus contact between the liquid and the textiles to be treated is avoided. As a result, damages, discoloration or other types of negative influences, especially on textiles which are not washable, can be avoided. At the same time however, moisture in the form of steam can leave the device via the at least one outlet opening and the textiles can thus be treated. The removal of odours during the airing process can thus be accelerated and improved compared with airing processes which exclusively use air.

At the same time, the device according to the invention allows a defined quantity of moisture to be brought into a laundry drier in the vapour phase and supplied into the interior of the drier.

The device according to the invention is preferably a separate device which can be brought into the drum of the laundry drier together with the textiles to be aired, possibly in a bag, and which can be removed from this again. The device thus preferably has no connection to the laundry drier. In one embodiment of the invention, however, the device can have at least one connecting means for connection to the drum of the laundry drier. As a result of this fixing of the device in the drum, a uniform supply of steam to the textiles located in the laundry drier can be ensured. The connecting means can be known means, such as for example, loops, hooks or clips.

Especially preferably, the device according to the invention is suitable for receiving water. As a result of the penetration of heat into the device, the water can be vaporised to form steam which can then penetrate as moisture into the drum and into the textiles located therein and thus, these can be treated.

At least one outlet opening is provided for dispensing moisture in the device according to the invention. This is preferably configured so that moisture can pass through the outlet opening in one direction but liquids cannot pass through the outlet opening. The outlet opening can, for example, be a tube or a hose in which a valve is provided. However, the outlet openings can also be pores in the material of the sleeve which only allow moisture to pass through in one direction. As a result of the last-mentioned embodiment in which the outlet openings are a part of the material of the sleeve in the form of pores, a sleeve can be provided which is overall impermeable to liquid and at the same time permeable to moisture.

In a further embodiment, the sleeve consists of a flexible material. The advantage of such a sleeve is that no damage to the textiles which are to be treated in the laundry drier is to be feared. Thus, the sleeve especially preferably consists of a membrane which is preferably semi-permeable for moisture, especially steam, and at the same time is watertight. Such membranes are sold for example by the company W.L. Gore & Associates under the trademark Goretex®. The semipermeability is preferably additionally direction-dependent, i.e., it allows the diffusion of moisture only from inside the device to the outside of the sleeve but not in the opposite direction.

In one embodiment the device further has a closeable filling opening for incorporating liquid into the receiving area. This filling opening allows the device to be used many times.

A carrier for liquids can be provided in the receiving area. As a result of this carrier, which can for example be a foam-like material, on the one hand the surface of the liquid provided or incorporated in the receiving area, can be increased whereby vaporisation of the liquid in the receiving area can be accelerated and on the other hand, transport of the device even in the filled state can be simplified by the carrier.

The device according to the invention for removing odours from textiles is preferably used in a laundry drier. In this use, the properties of the device according to the invention can be ideally used. Since the removal of odours by steam, for example, is especially carried out for textiles, which must normally undergo dry cleaning, it is of particular importance that the textiles do not come in contact with the liquid, e.g., the water located in the receiving area. In the device according to the invention, this is accomplished by the liquid-impermeable sleeve which nevertheless however, allows the supply of moisture in the steam phase, for example, via valves or pores of a membrane, into the interior of the drier.

Further, the object forming the basis of the invention is solved by a method for supplying moisture into the interior of a laundry drier, wherein a device, which contains liquid, is brought into the interior of the laundry drier, heat is produced by means of the heating device of the laundry drier, this heat brings the liquid in the device to vaporisation and the moisture thus obtained is dispensed via at least one outlet opening for moisture in the device to the interior of the drier.

The invention is described subsequently with reference to the appended drawings which relate to a possible exemplary embodiment of the invention. In the figures:

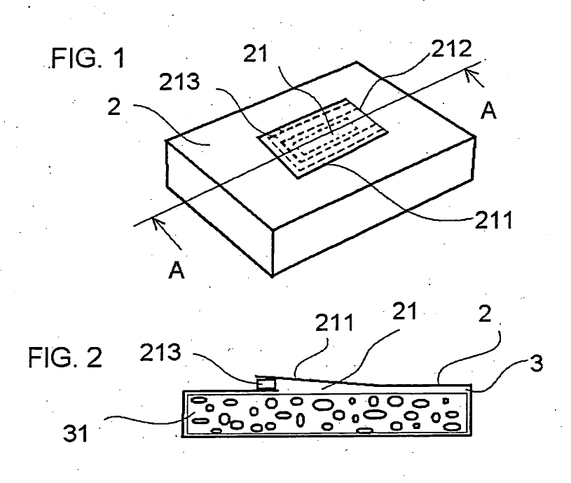

FIG. 1: is a schematic perspective view of an embodiment of a device according to the invention;

FIG. 2: is a schematic sectional view of the embodiment of the device according to the invention shown in FIG. 1.

FIG. 1 shows a possible embodiment of the device 1. In this embodiment the device 1 has a sleeve 2 which has a rectangular shape. A filling opening 21 is provided in the top of the sleeve 2. The filling opening 21 is covered by a lug 211. In the embodiment shown the lug 211 is larger than the filling opening 21. At one end 212 the lug 211 is fixedly connected to the sleeve 2. The free sides of the lug 211, i.e., the sides which extend over the filling opening 21 have on the underside, i.e., on the side facing the body, a velcro strip 213 by means of which the lug 211 can be connected to the outside of the sleeve 2. The filling opening 21 can thus be closed.

As can be seen from FIG. 2, a receiving area 3 is formed in the interior of the sleeve 2. In the embodiment shown a sponge 31 is contained in this receiving area 3 as a carrier for liquids. This sponge 31 can be impregnated with liquid, especially with water.

In the embodiment shown the material from which the sleeve 2 is made has pores (not shown) and is treated such that it allows moisture to pass from inside the sleeve 2 towards the outside but does not allow any liquid to enter in.

If, after being filled with water or another liquid and the filling opening 21 being closed by the lug 211, this device 1 is placed in the drum of a laundry drier, and this is switched on, the heating device of the laundry drier heats up. As a result, the device 1 and thus the liquid contained in the receiving area 3 is heated by the heating device of the laundry drier. On reaching a certain temperature, the liquid in the receiving area 3 vaporises and as a result of the semipermeability of the sleeve 2, can escape from the device on all sides via the pores of the membrane. The steam can penetrate into the textiles located in the drum, there bind the odorous substances to the water molecules and the odorous substances can be separated together with the water at a condenser or filter.

After the end of the airing process, the device 1 can be removed from the drum again, opened again and filled with water before being brought back into the drum for the next treatment process.

The size of the device is selected such that this can easily be inserted into the drum and nevertheless can accommodate a sufficient quantity of liquid to treat the textiles in the drum.

The embodiment shown in the figures is only one possibility in which the invention can be realised. For example, however, it is also possible to make the device from a liquid-tight and moisture-impermeable material and provide an opening for example, which is connected to a valve or in which a membrane can be provided via which moisture can escape but liquid is held in the device. A pressure valve can be used as the valve for example, which opens as a result of the pressure formed in the device as a result of the evaporation of the liquid and closes again directly after the pressure drops. In such an embodiment, the use of a carrier for the liquid in the receiving area is particularly important since this can largely prevent any escape of the liquid contained therein even when the valve is opened.

Furthermore, the device is not restricted to providing a filling opening in the device. It is also possible to select the material of the sleeve such that this is permeable in the direction from outside the device into the inside of the device, especially in the receiving area of the device for liquid but prevents any escape of liquid. In this embodiment the device can be filled with liquid, by dipping the device into the liquid and impregnating there with said liquid. Furthermore, the sleeve can be formed from a plurality of layers which together form the desired properties of the sleeve.

If a filling opening is provided, the device according to the invention is not restricted to the closure mechanism shown in the figures, rather other embodiments of velcro closure mechanisms or other closure means, such as zipper closures can also be used. Also the place where the filling opening is provided is not restricted to the position shown. For example, it is also within the scope of the invention to configure the sleeve in the form of a bag which can be opened completely on one side. A zipper closure mechanism, e.g. with longitudinal profiles, can also be provided on this side, by means of which the sleeve can be closed in a liquid-impermeable fashion, especially watertight.

If a filling opening is provided, it can be especially advantageous to provide a connecting means to the device by means of which the device can be connected to the drum. By means of the connection of the device to the drum it can be ensured by suitably positioning the connecting means that the filling opening and the means provided for closing and sealing the filling opening, such as velcro fasteners for example, are always facing the drum. Any damage to the textiles by the closure means can thus be prevented.

The shape of the device can also be differently selected so that this can have the form of a sphere, for example.

With the device according to the invention a moisture generator, especially a steam generator is provided which can be inserted in the drum of a laundry drier and, therein without having its own heat source, can produce moisture and dispense it to textiles without the textiles coming in contact with a liquid.

1-11. (canceled)

12. A device for supplying moisture into the interior of a laundry dryer, the device comprising:
a receiving area for receiving liquid; and
a liquid-impermeable sleeve surrounding the receiving area and having at least one outlet opening for dispensing moisture, the sleeve being heat-permeable.

13. The device according to claim 12, wherein the device has at least one connecting means for connection to the drum of the laundry dryer.

14. The device according to claim 12, wherein the device receives water.

15. The device according to claim 12, wherein the at least one outlet opening comprises pores in the material of the sleeve.

16. The device according claim 12, wherein the sleeve is made of a flexible material.

17. The device according to claim 15, wherein the sleeve includes a membrane semi-permeable for moisture.

18. The device according to claim 12, wherein the device in the sleeve further comprises a closeable filling opening for bringing liquid into the receiving area.

19. The device according to claim 12, further comprising a carrier for liquids in the receiving area.

20. The device according to claim 19, wherein the carrier is a sponge-like material.

21. The device according to claim 12, wherein the device removes odors from textiles in a laundry dryer.

22. A device for supplying moisture into the interior of a laundry dryer, the device comprising:
a sleeve defining an enclosed receiving area within the sleeve for retaining a liquid, the sleeve being made from a material being liquid-impermeable to resist the liquid from passing through the sleeve, heat-permeable to permit heat from the laundry dryer to act on the liquid within the sleeve and vaporize the liquid; and at least semi-permeable for moisture to permit the vaporized liquid to pass through the material and exit the sleeve; and
a carrier disposed within the receiving area and absorbing the liquid.

23. The device according to claim 22, wherein the sleeve is made from a porous material having multiple pores permitting moisture to pass through the pores and preventing liquid from passing through the pores.

24. The device according to claim 23, wherein the porous material only permits moisture to pass through the sleeve in one direction from inside the sleeve to outside the sleeve.

25. The device according to claim 22, wherein the sleeve is made from a flexible material.

24. The device according to claim 22, wherein the sleeve defines a filling opening for receiving the liquid into the receiving area and a resealable lug covering the opening and resisting the liquid from passing through the filling opening.

25. The device according to claim 22, wherein the sleeve includes a one-way pressure valve permitting moisture to exit the sleeve.

26. The device according to claim 22, wherein the carrier is made from a sponge material.

27. A method for supplying moisture into the interior of a laundry dryer, the method comprising the acts of:
providing a device that contains a liquid and includes at least one ouelet opening;
inserting the device in the interior of the laundry dryer;
producing heat by means of the heating device of the laundry dryer;
vaporizing the liquid within the device to generate moisture within the device;
dispensing the moisture within the device through the at least one outlet opening into the interior of the dryer.

28. The method of claim 27, wherein the sleeve device comprises:
a sleeve defining an enclosed receiving area within the sleeve for retaining a liquid, the sleeve being made from a material being liquid-impermeable to resist the liquid from passing through the sleeve, heat-permeable to permit heat from the laundry dryer to act on the liquid within the sleeve and vaporize the liquid; and at least semi-permeable for moisture to permit the vaporized liquid to pass through the material and exit the sleeve; and
a carrier disposed within the receiving area and absorbing the liquid.

29. The method of claim 28, wherein the sleeve is made from a porous material and the at least one outlet opening includes multiple pores permitting moisture to pass through the sleeve in one direction from inside the sleeve to outside the sleeve.

30. The method of claim 27, further comprising the act of removing odors from textiles within the laundry dryer.

31. The method of claim 27, further comprising the act of connecting the device to the drum of the laundry dryer.
